(19) United States
(12) Patent Application Publication
(10) Pub. No.: US 2018/0342347 A1
(43) Pub. Date: Nov. 29, 2018

(54) IGNITION COIL FOR INTERNAL COMBUSTION ENGINE

(71) Applicant: Hitachi Automotive Systems Hanshin, Ltd., Kobe-shi, Hyogo (JP)

(72) Inventor: Hiromi IDE, Kobe-shi (JP)

(73) Assignee: Hitachi Automotive Systems Hanshin, Ltd., Kobe-shi, Hyogo (JP)

(21) Appl. No.: 15/778,347

(22) PCT Filed: Nov. 25, 2016
(86) PCT No.: PCT/JP2016/004962

§ 371 Date: May 23, 2018

(30) Foreign Application Priority Data
Nov. 26, 2015 (JP) 2015-230668

(51) Int. Cl. H01F 38/12; H01T 13/05; H01F 27/33; F02P 3/02

(52) U.S. Cl. CPC H01F 38/12; F02P 3/02; H01F 27/33; H01T 13/05

(57) ABSTRACT

An ignition coil for an internal combustion engine capable of effectively preventing leakage of noise occurring due to, for example, radio waves or unpleasant sounds generated by a spark discharge is provided. When an elastic O-ring 12, which is a main part of the invention and which is made of a annular elastic resin material, is used as securing means, with a simple structure, it is possible to hold a second cap 9 (on a second electrode side) of an electric noise suppressing resistor 10 and to close a gap formed between an inner wall surface of a resistor accommodation section 4 and the second cap 9 of the electric noise suppressing resistor 10. Therefore, this ignition coil is characterized in that, after securing the electric noise suppressing resistor 10 to the resistor accommodation section 4 by using the elastic O-ring 12, even if the inside of the resistor accommodation section 4 is uniformly filled with the insulating material 5, it is possible to prevent leakage to a location below the resistor accommodation section 4 from occurring.

### TECHNICAL FIELD

The present invention relates to, for example, a mold-type ignition coil for an internal combustion engine, which supplies a high voltage for causing a spark discharge to occur in a spark plug for an engine of an automobile.

### BACKGROUND ART

Hitherto, in an internal combustion engine, a high voltage generated at an ignition coil causes a large electrical current to flow to a spark plug to cause a spark discharge to occur between the electrodes of the spark plug, so that fuel in a combustion chamber of the internal combustion engine is ignited by the spark discharge.

However, this method has a problem in that radio waves and unpleasant sounds are generated by the spark discharge at the spark plug, and thus the radio waves and the unpleasant sounds are transmitted to the surroundings and generate noise. In this case, electronic components in the internal combustion engine malfunction, which adversely affects even, for example, a computer that controls an engine, not to mention the ignition coil.

Accordingly, in order to suppress the noise generated by the spark discharge, ignition coils for an internal combustion engine, in which an electric noise suppressing resistor is connected in series between the ignition coil and the spark plug, are commercially available. The electric noise suppressing resistor of such existing ignition coils is held by a high-voltage connection terminal and a high-voltage output terminal at suitable locations in a container (refer to, for example, FIG. 2 in PTL 1).

### CITATION LIST

### Patent Literature

[PTL 1] Japanese Patent No. 4209400

### SUMMARY OF INVENTION

### Technical Problem

However, in the ignition coil for the internal combustion engine described in PTL 1, a gap is formed between the inner wall surface of a case at a portion where the electric noise suppressing resistor is accommodated and the outer wall surface of the electric noise suppressing resistor. Therefore, noise, occurring due to, for example, radio waves or unpleasant sounds, that is generated by the spark discharge leaks from, for example, the inner wall surface of the case, as a result of which various problems, such as the computer that controls the function of the engine malfunctioning due to noise, possibly occur.

The present invention is made for overcoming the above-described problems regarding existing ignition coils for an internal combustion engine, and it is an object of the present invention to provide an ignition coil for an internal combustion engine, which is capable of effectively preventing leakage of noise occurring due to, for example, radio waves or unpleasant sounds generated by a spark discharge.

### Solution to Problem

According to the present invention, there is provided an ignition coil for an internal combustion engine that causes a high voltage applied to a spark plug for the internal combustion engine to be generated, accommodates in a coil accommodation section, is secured by injecting an insulating resin into the coil accommodation section, solidifies the insulating resin, and has an electric noise suppressing resistor that prevents leakage of noise occurring due to radio waves or unpleasant sounds that are generated by the ignition coil. The ignition coil comprises a resistor accommodation section that is a cylindrical internal space portion communicating with the coil accommodation section, that is provided at a portion below the coil accommodation section when injecting the resin into the coil accommodation section. A first electrode of the electric noise suppressing resistor is positioned at an upper side the resistor accommodation section being a side of the coil accommodation section, and a second electrode of the electric noise suppressing resistor is positioned at a lower side being a side opposite to the upper side. The resistor accommodation section includes securing means, below the resistor accommodation section, for holding a side of the second electrode of the electric noise suppressing resistor and for closing a gap formed between an inner wall surface of the resistor accommodation section and the side of the second electrode of the electric noise suppressing resistor. The resistor accommodation section includes a securing means holding section for holding the securing means at a required position. The securing means holding section has a plurality of upper protruding portions disposed at equal intervals in an inner peripheral direction of the resistor accommodation section, and a plurality of lower protruding portions provided below the upper protruding portions by a distance corresponding to a vertical width of the securing means and are disposed at equal intervals in the inner peripheral direction of the resistor accommodation section. The upper protruding portions and the lower protruding portions are alternately provided so as not to overlap each other in a circumferential direction as viewed from an axial direction of the resistor accommodation section being the cylindrical shape.

According to the present invention, a closed-bottom cylindrical first cap made of an electrically conductive material is mounted on the first electrode of the electric noise suppressing resistor, and a closed-bottom cylindrical second cap made of an electrically conductive material is mounted on the second electrode of the electric noise suppressing resistor. The securing means closes an annular gap formed between the inner wall surface of the resistor accommodation section and the second cap, and secures the electric noise suppressing resistor via the second cap.

According to the present invention, the securing means is an annular O-ring made of an elastic resin material.

### Advantageous Effects of Invention

According to the ignition coil for the internal combustion engine of the present invention, when insulating resin is injected from the coil accommodation section with the electric noise suppressing resistor being held in the resistor accommodation section by the securing means, the insulating resin does not leak out to a location below the resistor accommodation section, and a portion between the resistor accommodation section and the electric noise suppressing resistor is filled with the insulating resin. Therefore, when the insulating resin is solidified, a portion between the inner wall surface of the resistor accommodation section and the outer wall surface of the electric noise suppressing resistor is filled with the insulating material, so that, while the electric noise suppressing resistor effectively suppresses the leakage of noise occurring due to radio waves or unpleasant sounds generated by the application of a high voltage to the spark plug by the ignition coil, it is possible to prevent creeping leakage at the portion between the electric noise suppressing resistor and the inner wall surface of the resistor accommodation section.

Since the securing means holding section for holding the securing means at a required position is formed from the plurality of upper protruding portions and the plurality of lower protruding portions, and the upper protruding portions and the lower protruding portions are disposed so as not to overlap each other in the circumferential direction, the securing means holding section can be molded by a mold of an upper-lower parting type.

### BRIEF DESCRIPTION OF DRAWINGS

FIG. 1 is a schematic sectional view of an ignition coil for an internal combustion engine of the present invention.

FIG. 2 is a sectional view of protruding portions that are provided on an inner wall of a resistor accommodation section of the ignition coil for the internal combustion engine of the present invention.

### DESCRIPTION OF EMBODIMENTS

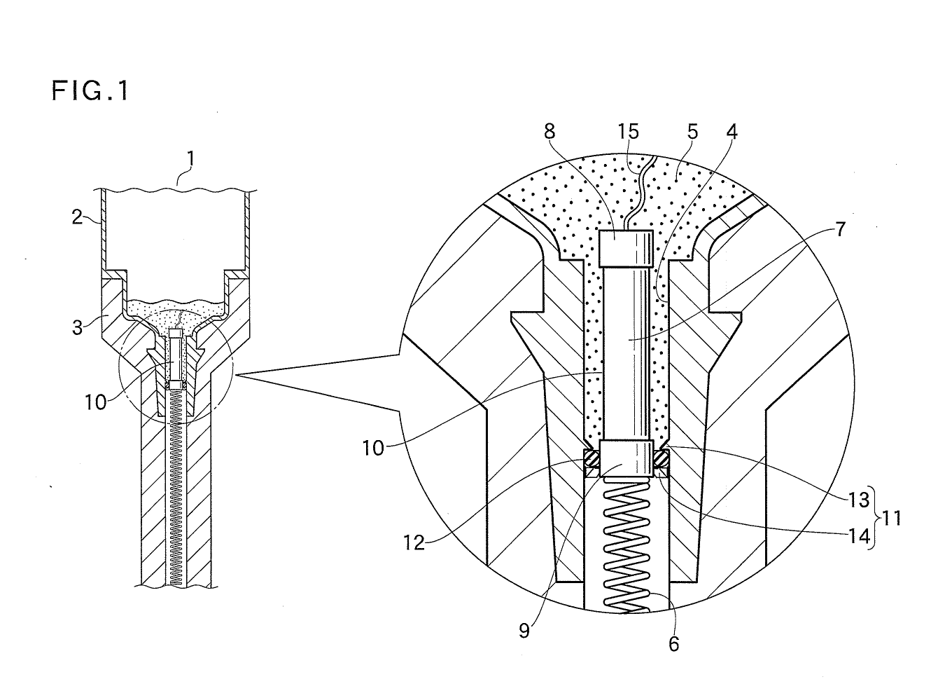

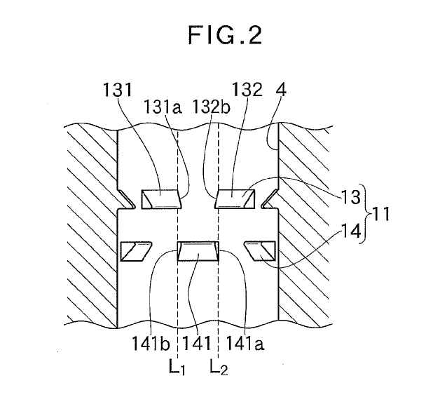

An ignition coil for an internal combustion engine of the present invention is described in detail below on the basis of the drawings. FIG. 1 is a schematic sectional view of the ignition coil for the internal combustion engine of the present invention. FIG. 2 is a sectional view of protruding portions that are provided on an inner wall of a resistor accommodation section.

First, a structure of the ignition coil 1 for the internal combustion engine of the present invention is described.

The ignition coil 1 for the internal combustion engine includes an accommodation case 2 that forms an accommodation section that accommodates therein, for example, an iron core, a bobbin, a primary coil, a secondary coil, and an igniter (none of which are shown).

As shown in FIG. 1, an insulating case 3 is integrally mounted on the accommodation case 2, and a spark plug (not shown) is connected. A resistor accommodation section 4 that has a substantially cylindrical shape and that accommodates an electric noise suppressing resistor 10 for suppressing noise occurring due to, for example, radio waves or unpleasant sounds is formed at a lower portion of the accommodation case 2. The electric noise suppressing resistor 10 having a substantially cylindrical shape is disposed at the center of the inside of the resistor accommodation section 4.

After installing, for example, the ignition coil and the igniter in the accommodation case 2 of the ignition coil 1 for the internal combustion engine, a resin material for forming an insulating material 5, which is an insulating resin, fills a coil accommodation section of the accommodation case 2, and penetrates a gap between the members in the accommodation case 2 so as to fill the gap. The insulating material 5 that is formed by solidifying the resin material reliably electrically insulates a portion between the members.

Here, the resistor accommodation section 4 communicates with the coil accommodation section of the accommodation case 2, and at least during the filling operation using the insulating material 5, the resistor accommodation section 4 is positioned below the coil accommodation section. Therefore, when the resin material is introduced into the accommodation case 2 for forming the insulating material 5 that insulates and holds the ignition coil, the inside of the resistor accommodation section 4 is also filled with the insulating resin.

When the injected resin material is solidified and becomes the insulating material 5, a portion between an inner wall surface of the resistor accommodation section 4 and an outer wall surface of the electric noise suppressing resistor 10 is filled with the insulating material 5. Therefore, while effectively suppressing the leakage of noise occurring due to radio waves or unpleasant sounds generated by the application of a high voltage to the spark plug by the ignition coil, it is possible to prevent creeping leakage at the portion between the electric noise suppressing resistor 10 and the inner wall surface of the resistor accommodation section 4.

However, when the resin material fills the resistor accommodation section 4 as described above, if a lower limit of the resistor accommodation section 4 that is filled with the resin material is not reliably closed at least until the insulating material 5 is solidified, the resin material that has filled the resistor accommodation section 4 may leak out to a location below the resistor accommodation section 4. In this case, the insulating material 5 that has leaked out may adhere to, for example, a coil spring 6 or the like, and adversely affect the entire ignition coil. This may become a huge problem in terms of quality. A detailed structure for preventing such a problem from occurring is described below.

First, the structure of the electric noise suppressing resistor 10 is described.

As shown in FIG. 1, the substantially cylindrical electric noise suppressing resistor 10 that is disposed at the center of the inside of the resistor accommodation section 4 has a structure including a closed-bottom cylindrical first cap 8 and a closed-bottom cylindrical second cap 9. The first cap 8 is made of an electrically conductive metal and disposed on one end (such as a first electrode that becomes an upper portion) of a resistor body 7 whose base material is ceramic. The second cap 9 is made of an electrically conductive metal and is disposed on another end (such as a second electrode that becomes a lower portion) thereof. Since, as the electric noise suppressing resistor 10 having such a form, a generally standardized, inexpensive insulator can be used, costs can be reduced. The base material of the electric noise suppressing resistor is not limited to ceramic, and thus may be anything capable of suppressing noise, such as a winding.

The first cap 8 is electrically connected to the secondary coil (not shown) via a connection wire 15. The second cap 9 is electrically connected to the spark plug (not shown) via the coil spring 6. The second cap 9 is secured by an O-shaped elastic O-ring 12 that is held by an O-ring holding section 11 including a plurality of upper protruding portions 13 and a plurality of lower protruding portions 14 (described later).

The inside diameter of the elastic O-ring 12 is smaller than the size of the outside diameter of the second cap 9. When the electric noise suppressing resistor 10 is pushed in from above the elastic O-ring 12, the second cap 9 is press-fitted to an internal space portion of the elastic O-ring 12, and the internal space portion of the elastic O-ring 12 and the second cap 9 closely contact each other without a gap therebetween. In addition, since a force that increases the size of an outer peripheral surface of the elastic O-ring 12 where the diameter of the internal space portion has been increased acts thereupon, the outer periphery of the elastic O-ring 12 also closely contacts an inner peripheral surface of the resistor accommodation section 4 without a gap therebetween.

When the elastic O-ring 12 having a ring-shape and made of an elastic resin material is used as securing means in this way, by using a simple structure, it is possible to hold the second cap 9 (the second-electrode side) of the electric noise suppressing resistor 10 and to close a gap that is formed between the inner wall surface of the resistor accommodation section 4 and the second cap 9 of the electric noise suppressing resistor 10. Therefore, after securing the electric noise suppressing resistor 10 to the resistor accommodation section 4 by using the elastic O-ring 12, even if the inside of the resistor accommodation section 4 is uniformly filled with the insulating material 5, leakage to a location below the resistor accommodation section 4 does not occur.

Next, a structure of the O-ring holding section 11 for holding the elastic O-ring 12 is described.

As shown in FIG. 2, the O-ring holding section 11 includes, on an inner wall of the resistor accommodation section 4, a plurality of (for example, six) upper protruding portions 13 and a plurality of (for example, six) lower protruding portions 14, which are discontinuously disposed at substantially equal intervals in an inner peripheral direction of the inner wall. A space having a width that allows the elastic O-ring 12 to be exactly fitted therein is formed between the positions of the upper protruding portions 13 and the positions of the lower protruding portions 14.

The upper protruding portions 13 and the lower protruding portions 14 of the O-ring holding section 11 are alternately provided so as not to overlap each other in a circumferential direction as viewed from an axial direction of the resistor accommodation section 4, which is an internal space portion having a substantially cylindrical shape. As a specific example, a relationship of first upper protruding portions 131 and second upper protruding portions 132, which are two types of adjacent upper protruding portions, to first lower protruding portions 141, which are lower protruding portions, positioned exactly in correspondence with locations between the first upper protruding portions 131 and the corresponding second upper protruding portions 132 is shown in FIG. 2. First end surfaces 131a (right surfaces in the plane of FIG. 2) of the first upper protruding portions 131 and second end surfaces 141b (left surfaces in the plane of FIG. 2) of the first lower protruding portions 141 are disposed so as not to overlap an imaginary dividing line L1 that is parallel to an axis of the resistor accommodation section 4. Second end surfaces 132b (left surfaces in the plane of FIG. 2) of the second upper protruding portions 132 and first end surfaces 141a (right surfaces in the plane of FIG. 2) of the first lower protruding portions 141 are disposed so as not to overlap an imaginary dividing line L2 that is parallel to the axis of the resistor accommodation section 4. Since this arrangement relationship is maintained by all of the upper protruding portions 13 and the lower protruding portions 14 of the O-ring holding section 11, the upper protruding portions 13 and the lower protruding portions 14 are easily molded by using a mold of an upper-lower parting type.

Since the elastic O-ring 12 made of a resin, such as silicone rubber, can be elastically deformed and fitted into portions between the alternately provided upper protruding portions 13 and lower protruding portions 14, it is possible to easily insert the elastic O-ring 12 into the O-ring holding section 11, and the elastic O-ring 12 held by the O-ring holding section 11 does not easily slip down. Therefore, by using a simple structure, it is possible to realize the securing means holding section that is capable of properly holding the elastic O-ring 12, which is securing means.

The amount of protrusion of the upper protruding portions 13 and the lower protruding portions 14 from the inner wall surface of the resistor accommodation section 4 is set as appropriate such that even if the elastic O-ring 12 is held by the O-ring holding section 11 and the second cap 9 of the electric noise suppressing resistor 10 is press-fitted to the internal space portion of the elastic O-ring 12, the second cap 9 is not pushed against the upper protruding portions 13 and the lower protruding portions 14.

Although, in the above-described embodiment, the elastic O-ring 12 is used as the securing means for securing the electric noise suppressing resistor 10, the securing means is not limited thereto. Any sealing material may be used as long as the second-electrode side of the electric noise suppressing resistor 10 is held and a gap formed between the inner wall surface of the resistor accommodation section 4 and the second-electrode side of the electric noise suppressing resistor 10 can be closed.

### REFERENCE SIGNS LIST

1 ignition coil for internal combustion engine

2 accommodation case

3 insulating case

4 resistor accommodation section

5 insulating material

6 coil spring

7 resistor body

8 first cap

9 second cap

10 resistor

11 protruding portion

12 elastic O-ring

13 upper protruding portion

14 lower protruding portion

15 connection wire

1. An ignition coil for an internal combustion engine, the ignition coil causing a high voltage applied to a spark plug for the internal combustion engine to be generated, accommodated in a coil accommodation section, secured by injecting an insulating resin into the coil accommodation section, solidifying the insulating resin, and having an electric noise suppressing resistor that prevents leakage of noise occurring due to radio waves or unpleasant sounds that are generated by the ignition coil,
the ignition coil comprising:
a resistor accommodation section being a cylindrical space portion communicating with the coil accommodation section, being provided at a portion below the coil accommodation section when injecting the resin into the coil accommodation section,
wherein a first electrode of the electric noise suppressing resistor is positioned at an upper side the resistor accommodation section being a side of the coil accommodation section, and a second electrode of the electric noise suppressing resistor is positioned at a lower side being a side opposite to the upper side,
the resistor accommodation section including securing means, below the resistor accommodation section, for holding a side of the second electrode of the electric noise suppressing resistor and for closing a gap formed between an inner wall surface of the resistor accommodation section and the side of the second electrode of the electric noise suppressing resistor, and
a securing means holding section for holding the securing means at a required position, having
a plurality of upper protruding portions disposed at equal intervals in an inner peripheral direction of the resistor accommodation section, and
a plurality of lower protruding portions provided below the upper protruding portions by a distance corresponding to a vertical width of the securing means and are disposed at equal intervals in the inner peripheral direction of the resistor accommodation section, and
wherein the upper protruding portions and the lower protruding portions are alternately provided so as not to overlap each other in a circumferential direction as viewed from an axial direction of the resistor accommodation section being the cylindrical shape.

2. The ignition coil for the internal combustion engine according to claim 1, wherein a closed-bottom cylindrical first cap made of an electrically conductive material is mounted on the first electrode of the electric noise suppressing resistor, and a closed-bottom cylindrical second cap made of an electrically conductive material is mounted on the second electrode of the electric noise suppressing resistor, and
wherein the securing means closes an annular gap formed between the inner wall surface of the resistor accommodation section and the second cap, and secures the electric noise suppressing resistor via the second cap.

3. The ignition coil for the internal combustion engine according to claim 2, wherein the securing means is an annular O-ring made of an elastic resin material.
